(19) United States
(12) Patent Application Publication
(10) Pub. No.: US 2011/0022591 A1
(43) Pub. Date: Jan. 27, 2011

(54) Pre-computed ranking using proximity terms

(76) Inventors: Oscar B. Stiffelman, San Francisco, CA (US); William J. Mydlowec, San Francisco, CA (US)

Correspondence Address: RAYMOND R. MOSER JR., ESQ.;MOSER IP LAW GROUP, 1030 BROAD STREET, SUITE 203, SHREWSBURY, NJ, 07702, US

(21) Appl. No.: 12/804,645

(22) Filed: Jul. 26, 2010

Related U.S. Application Data
(60) Provisional application No. 61/271,671, filed on Jul. 24, 2009.

(51) Int. Cl. G06F 17/30

(52) U.S. Cl. 707/728; 707/E17.014; 707/E17.008

(57) ABSTRACT

A method for searching the web comprising an off-line phase for generating a numerical score for at least one term within a document retrieved from the web, and an on-line phase comprising accessing the numerical score for the at least one term when the at least one term is used as a search term within a query. The numerical score is used to identify documents to include in a search result.

### CROSS-REFERENCE TO RELATED APPLICATIONS

This application claims priority to U.S. Provisional Patent Application Ser. No. 61/271,671 filed Jul. 24, 2009, which is incorporated by reference herein in its entirety.

### BACKGROUND OF THE INVENTION

1. Field of the Invention

Embodiments of the invention relates to the field of information retrieval and, in particular, to search engines for the World Wide Web (the “web”).

2. Description of the Related Art

### I. Background on Search Engines

The web comprises a myriad of computers interconnected by a communications network. Each computer stores and presents a plurality of documents to users of the web. The process of searching the web comprises multiple steps divided into two phases: an off-line phase and an on-line phase. During the off-line phase, an index of keywords to documents stored on the web is created. During the on-line phase, this index is searched in order to produce results for a user-specified query.

One known technique for performing the off-line phase is shown in method 100 of FIG. 1. The first step 102 in the off-line phase acquires the documents to be searched. Typically, this step involves sending a large number of Hypertext Transfer Protocol (HTTP) requests to retrieve Hypertext Markup Language (HTML) documents from the World Wide Web. Other data protocols, formats, and sources may also be utilized to acquire documents.

The second step 103 in the off-line phase inverts any links between the documents acquired in step 102. A link represents a reference from a source document to a destination document. For example, most HTML documents on the web contain “anchor” tags that explicitly reference other documents by Universal Research Locator (URL). During the link inversion step 103, links are collected by destination document instead of source. After link inversion is completed, each document contains a list of all other documents that reference it. The text from these incoming links (“anchortext”) provides an important source of annotation for a document. Note that the number of incoming links is unbounded, and often will greatly exceed the amount of text in the document itself.

The third step 104 in the off-line phase enumerates a set of keywords or “terms” for each document. These terms represent the most important aspects of the document. The terms are generated from the document title, the on-page text, and the anchortext. A wide variety of techniques may be employed for selecting or filtering terms.

The fourth step 105 in the off-line phase builds an index of the terms generated in step 104. Each entry in the index is called a “posting list” and comprises a term, followed by a list of all documents containing the term, in addition to metadata. The metadata consists of the positions (offsets) of the term within a document, in the title of a document, and in the anchortext of a document. Additional metadata may include other document features, for example font size and color. Note that, because the amount of anchortext is unbounded, the amount of metadata in the posting list is also unbounded.

Once all documents have been added to the index, the off-line phase 100 is complete. The on-line phase 101, depicted in FIG. 2, begins when a user submits a query to the search engine. A query is a set (string) of words that contains terms.

The first step 106 in the on-line phase parses the query. Typically, this step involves breaking the query into unigram terms. For example, the query new york restaurants is broken into the unigram terms: new, york, and restaurants. Additional query processing, such as removal of very common terms (e.g., a, the, an, and the like), may also be performed at this step. In general, a wide variety of algorithms and techniques may be employed to parse the query.

The second step 107 in the on-line phase is posting list intersection. For each unigram term generated in step 106, the corresponding posting list from step 105 is retrieved from the index. In the example above, the posting lists for new, york, and restaurants (three separate lists) would be retrieved. A logical intersection is then performed on the retrieved posting lists, thereby eliminating any document not present in every list. For example, a document that contains the word new but not the word york would be eliminated during intersection. All documents that survive the intersection are potential matches for the query.

The third step 108 in the on-line phase reconstructs term matches. A term match is an instance of a query term matching a term in a document, its title, or anchortext. The positional information stored in the posting list metadata during step 105 is used to determine if the term matches occur in close proximity to each other. For example, if the term new occurs at position 2, and the term york occurs at position 3, the system can reconstruct the contiguous phrase new york.

The fourth step 109 in the on-line phase scores the documents that survived the intersection in step 107. A ranking function is employed to calculate the document scores. The ranking function takes as input all of a document's term matches (generated in step 108) and produces as output a single numerical value for the document. The ranking function is often a complex algorithm that transforms, normalizes, and combines its inputs. A wide variety of different functions and structures can be used for calculating document scores.

The final step 110 in the on-line phase selects a subset of documents that survived the intersection in step 107 based on the document scores computed in step 109. A variety of algorithms may be employed at this step. For example, filtering and sorting of documents based on scores. The selected subset of documents is then returned in part or entirety to the user. This marks the end of the on-line phase 101.

### II. Background on Pre-Computed Ranking

In order to minimize resources required during the on-line phase of processing, pre-computation of the ranking function is possible. However, previously available techniques for pre-computed ranking can substantially alter search results and reduce quality.

Pre-computed ranking can be performed during the off-line phase after step 105. The simplest approach to pre-computation is to score each term in every document separately. The pre-computed scores may be stored in the posting list instead of the positional information. This eliminates step 108 of the on-line phase, which uses the positional information to reconstruct the location of term matches.

The drawback of this approach is that information about the proximity of terms is lost. For example, the query new york restaurants is treated as a simple combination of the scores for the terms: new, york, and restaurants. Using this decomposition, there is no way to distinguish whether the given terms occurred near or adjacent to each other. Thus, applying this form of pre-computed ranking can significantly alter the search results and reduce search quality.

Another previously available approach to pre-computed ranking, indexes phrases instead of unigrams. In the pre-computed phrase-based index, the example query new york restaurants is decomposed into two separate phrases: new york and restaurants, and their two corresponding posting lists are used for intersection and ranking. One example of this approach is described in US patent application publication 2006/0020607A1, incorporated herein by reference in its entirety.

In the phrase-based approach, proximity information is preserved within a phrase but it is still lost between phrases. In the above example, it is possible to determine whether a document contains the words new and york adjacent to each other, but there is no way to distinguish whether the phrase restaurants occurred near or adjacent to the phrase new york.

Another drawback of the pre-computed phrase-based index is that it significantly affects which documents survive the logical intersection (step 107). For example, if the system indexes the phrase hillary rodham clinton from a document, and identifies the phrase hillary clinton in a query, the longer phrase from the document would not be considered a match for the shorter phrase in the query, causing the document to be incorrectly eliminated during logical intersection. Thus, employing a pre-computed phrase-based index can significantly alter the search results and reduce quality.

Therefore, there is a need for an improved web searching techniques.

### SUMMARY

Embodiments of the invention comprise a method of searching the web using two phases: an off-line phase and an on-line phase. Embodiments of the present invention include a method for searching the web comprising an off-line phase for generating a numerical score for at least one term within a document retrieved from the web, and an on-line phase comprising accessing the numerical score for the at least one term when the at least one term is used as a search term within a query. The numerical score is used to identify documents to include in a search result.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram of an off-line method used by current search engines;

FIG. 2 is a flow diagram of an on-line method used by current search engines;

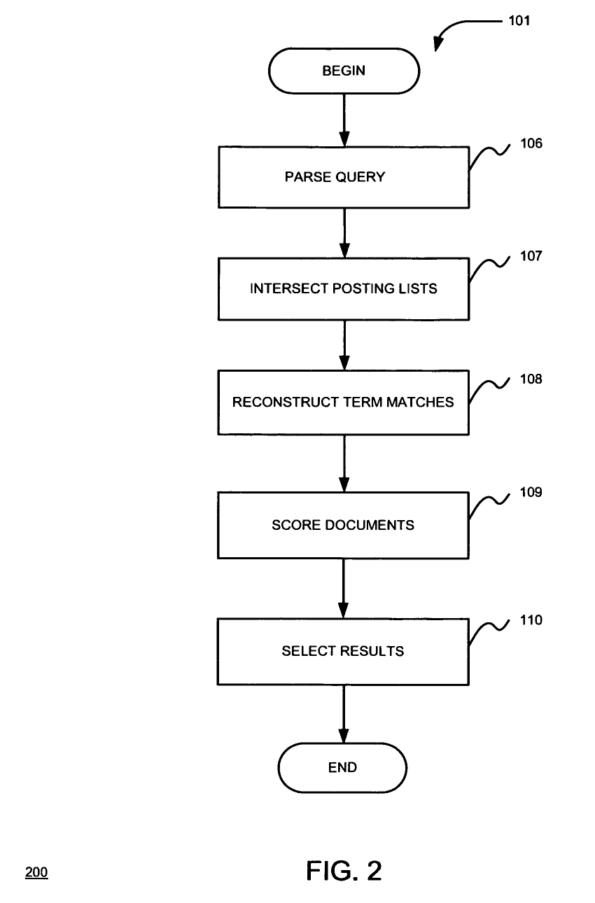

FIG. 3 is a flow diagram of an off-line method used by one embodiment of the present invention;

FIG. 4 is a flow diagram of an on-line method used by one embodiment of the present invention; and

FIG. 5 depicts a block diagram of a computer system used to perform the methods of various embodiments of the present invention.

### DETAILED DESCRIPTION

Embodiments of the present invention minimize latency after a query has been issued by a user and before results have been returned to the user. Embodiments of the present invention also reduce storage space required for an index used in the search process. In addition, embodiments of the present invention reduce latency and space without substantially changing the results returned for a given search.

Specifically, embodiments of the present invention pre-compute a ranking function using “proximity terms”. Proximity terms preserve information about term locality that is lost in previously available approaches to pre-computed ranking. Proximity terms do not necessarily restrict which documents survive the logical intersection, so as not to alter the search results significantly.

In one embodiment of the invention, proximity terms are generated using the following procedure; however, other procedures may be used. A proximity window of size N words is used to traverse a given text string comprised of M words. The proximity window starts at the first word in the text string, extending N words to the right. This window is shifted right M−N times. At each window position, there will be N words (or fewer) in the proximity window. Proximity terms are produced by enumerating the power set of all words in the proximity window at each window position. Note that proximity terms are not limited to contiguous words or phrases. In one embodiment, some of the enumerated proximity terms may be filtered based on criteria such as frequency of occurrence. In another embodiment, proximity terms comprised of 2 words are used. In other embodiments, proximity terms comprised of more than 2 words may be used.

Consider the example of the text string hillary rodham clinton. Embodiments of the present invention decompose this text into the unigram terms: hillary, rodham, and clinton; and the proximity terms: hillary rodham, rodham clinton, and binary clinton.

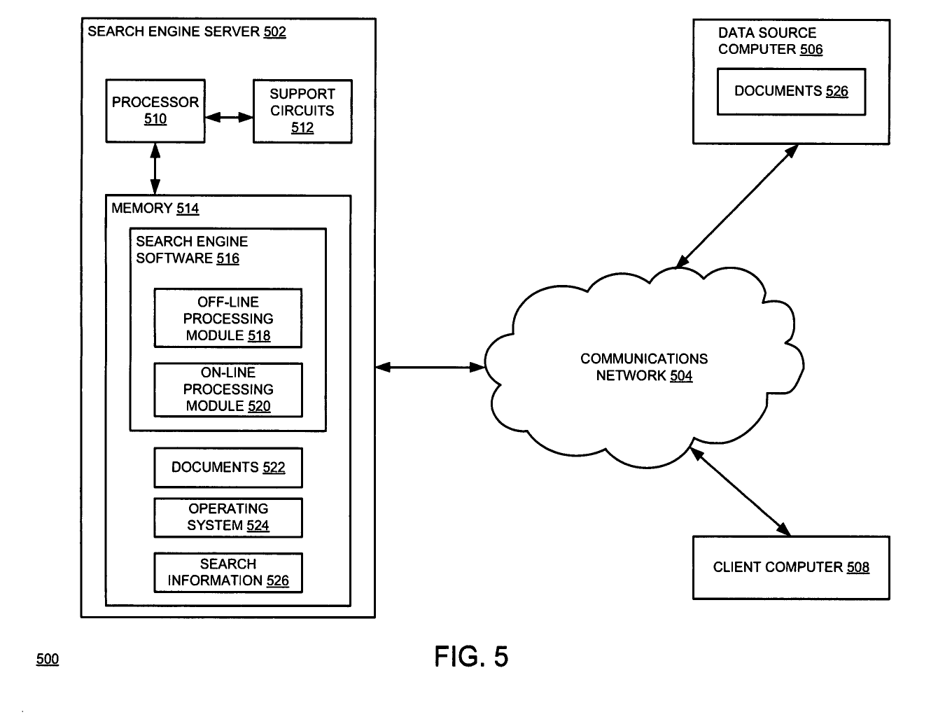

Embodiments of the present invention are implemented using a general-purpose computer programmed to operate as a specific purpose computer to perform the procedures described below. FIG. 5 depicts a computer system 500 comprising a search engine server 502, a communications network 504, data source computer 506 and at least one client computer (client 508). The system 500 enables a client 508 to interact with the search engine server 502 via the network 504, identify data (documents) at one or more data source computers 506 and display and/or retrieve the data from the data source computers 506.

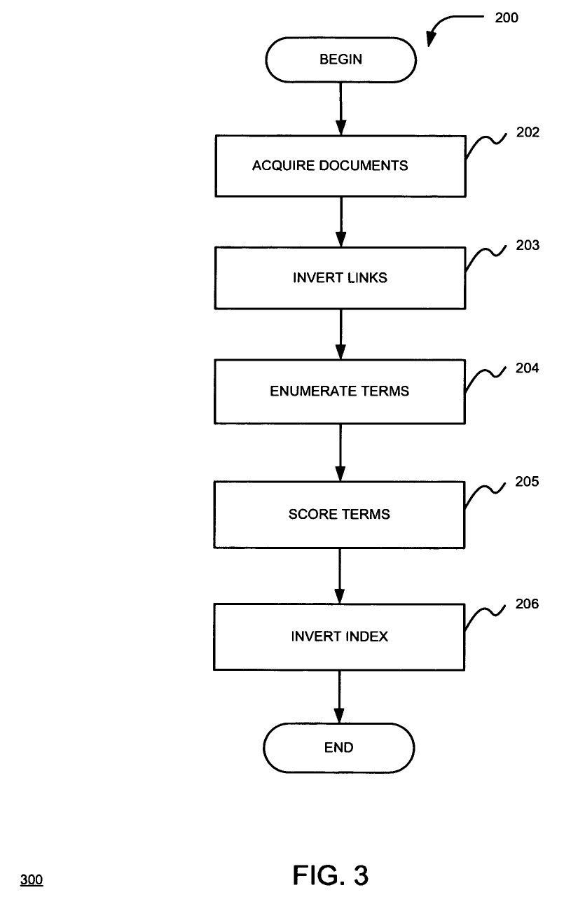

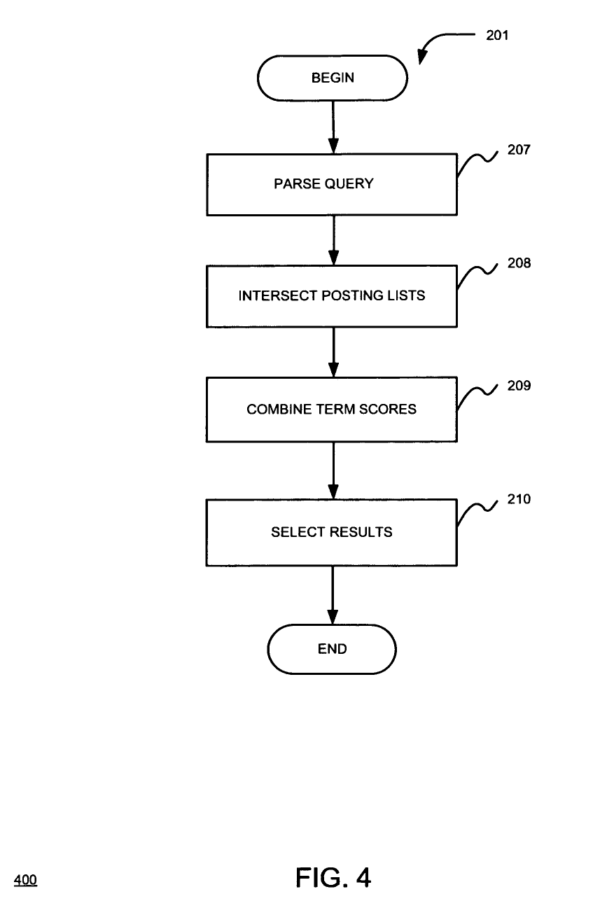

The search engine server 502 comprises a processor 510, support circuits 512 and memory 514. The processor 510 comprises one or more generally available microprocessors used to provide functionality to a computer server. The support circuits 512 support the operation of the processor 510. The support circuits 512 are well known circuits comprising, for example, communications circuits, input/output devices, cache, power supplies, clock circuits, and the like. The memory 514 comprises various forms of solid state, magnetic and optical memory used by a computer to store information and programs including but not limited to random access memory, read only memory, disk drives, optical drives and the like. The memory 514 stores search engine software 516, documents 522 and operating system 524 and search information 526. The operating system 524 may be one of many commercially available operating systems such as LINUX, UNIX, OSX, WINDOWS and the like. The documents 522 are typically stored in a database. The search information 526 comprises posting lists, indices and other information created and used by the search engine software 516 to perform searching as described below with respect to FIGS. 3 and 4. The search engine software 516 comprises two main components relevant to the invention: off-line processing module 518 and on-line processing module 520.

In operation, the search engine server 502 acquires documents 522 from the data source computers 506, creates indices and other information (search information 526) related to the documents 522 (stored copies of documents 526) using the off-line processing module 518 of the search engine software 516. The client computer 508 using well-known browser technology sends a query to the search engine server. The search engine server uses the on-line processing module 520 to process the query and return to the client computer 508 for display results of a search that is responsive to the query.

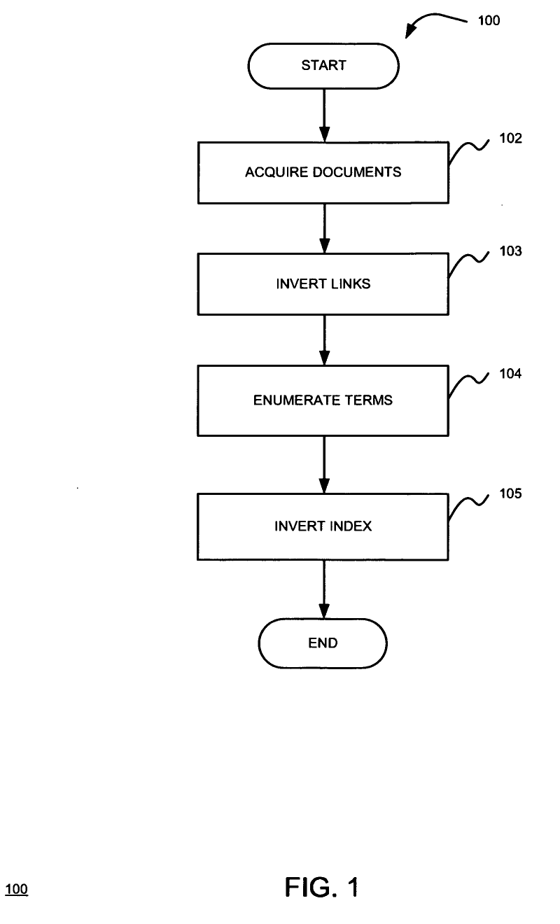

More specifically, the process used in one embodiment of the present invention, as shown in FIGS. 3 and 4, is divided into two phases: an off-line phase 200 (performed by executing off-line processing module 518) and an on-line phase 201 (performed by executing on-line processing module 520). The first step 202 in the off-line phase acquires the documents to be searched. The second step 203 in the off-line phase inverts any links between the acquired documents. These steps are equivalent to steps (102) and (103) in the background process of FIG. 1.

The third step 204 in the off-line phase enumerates the terms for each document, which are generated from the document title, the on-page text, and the anchortext. Embodiments of the present invention enumerate both unigrams terms, as in the previously available technique, and proximity terms, as described above.

The fourth step 205 in the off-line phase calculates numerical scores for each of the terms generated in the previous step. A ranking function is employed to pre-compute a single numerical score for each term generated in step 204. Note that by performing ranking off-line, scores can be computed using the full context of the document, including metadata such as font size and color, and non-local information such as its link structure on the web.

The fifth step 206 in the off-line phase builds an index of the terms generated in step 204 and their numerical scores. In various embodiments of the present invention, both unigram terms and proximity terms are indexed as posting lists. No positional information is stored in these posting lists. Only a single numerical value, the pre-computed term score produced in step 205, is stored as part of the posting list for the document. This significantly reduces the storage space required for the index.

Once all documents have been added to the inverted index, the off-line phase 200 is complete. The on-line phase 201 of FIG. 4 begins when a user submits a query to the search engine.

The first step 207 in the on-line phase parses the query into terms. This is similar to step 106 in the previously available process, except that, in one embodiment of the present invention, both unigram terms and proximity terms are generated.

The second step 208 in the on-line phase performs posting list intersection. For each unigram term generated in step 207, the corresponding posting list from step 206 is retrieved from the index. A logical intersection is then performed on the unigram posting lists representing the documents to determine documents that contain terms that intersect the index (i.e., intersecting terms). All documents that survive the unigram intersection are potential matches for the query. In one embodiment, proximity terms and their associated posting lists are not used to restrict the logical intersection. In other embodiments, proximity terms may optionally be used to restrict the logical intersection.

The third step 209 in the on-line phase combines the numerical scores of the intersecting terms of each candidate document to produce a document numerical score. For all documents that survive the intersection in the previous step, the unigram and proximity term scores (generated in step 206) are retrieved from the posting lists. A combination function is then applied to the term scores in order to produce a single numerical score for each document containing an intersecting term (i.e., produce a document numerical score). In one embodiment, a summation function is used for the combination function. In other embodiments, alternative functions may be used as the combination function. Note that proximity term scores are always used during this step, even if they were not used to restrict the logical intersection during step 208.

The final step 210 in the on-line phase selects a subset of the documents that survived the intersection (in step 208) based on the document numerical scores from step 209. Various different algorithms may be used at this step, for example filtering and sorting of documents based on their numerical scores. The resulting selected subset of documents is then returned in part or entirety to the user. This marks the end of the on-line phase 201.

While the foregoing is directed to embodiments of the present invention, other and further embodiments of the invention may be devised without departing from the basic scope thereof, and the scope thereof is determined by the claims that follow.

1. A method for searching the web comprising:
an off-line phase comprising generating a numerical score for at least one term within a document retrieved from the web; and
an on-line phase comprising accessing the numerical score for the at least one term when the at least one term is used as a search term within a query.

2. The method of claim 1, wherein the at least one term and the numerical score for the at least one term form at least a portion of an index.

3. The method of claim 1 where in the on-line phase combines numerical scores for a plurality of terms to determine search results.

4. The method of claim 1 wherein the at least one term is at least one of a unigram term or a proximity term.

5. The method of claim 1, wherein the off-line phase further comprises:
(i) acquiring a document from the web to be searched;
(ii) inverting links between the document and other documents;
(iii) enumerating at least one term from the document;
(iv) computing the numerical score for the at least one term; and
(v) building an index comprising the at least one term and at least one numerical score representing the document.

6. The method of claim 5, wherein the enumerating at least one term comprises generating at least one unigram term and at least one set of proximity terms.

7. The method of claim 5, wherein computing the numerical score for the at least one term is performed using the full context of the document.

8. The method of claim 5, wherein the at least one term and the numerical score for the at least one term form at least a portion of an index.

9. The method of claim 1, wherein the on-line phase further comprises:
(i) parsing a user query into at least one term;
(ii) performing a logical intersection of the at least one term and an index representing a plurality of documents to determine at least one intersecting term representing a candidate document;
(iii) combining the numerical score of the at least one intersecting term to produce a document numerical score for the candidate document; and
(iv) selecting, based upon the document numerical score, at least one candidate document as a search result.

10. The method of claim 9, wherein performing the logical intersection comprises retrieving a corresponding posting list for the at least one term.

11. The method of claim 10, wherein the logical intersection is performed on the documents represented in a posting list.

12. The method of claim 9, wherein a unigram term numerical score and a proximity term numerical score are combined to create the numerical score for the candidate document.

13. The method of claim 1, wherein the off-line phase further comprises:
(i) acquiring a document from the web to be searched;
(ii) inverting links between the document and other documents;
(iii) enumerating at least one term from the document;
(iv) computing the numerical score for the at least one term; and
(v) building an index comprising the at least one term and at least one numerical score representing the document;
wherein the on-line phase further comprises:
(vi) parsing a user query into at least one query term;
(vii) performing a logical intersection of the at least one query term and the index to determine at least one intersecting term representing a candidate document;
(viii) combining the numerical score of the at least one intersecting term to produce a document numerical score for the candidate document; and
(ix) selecting, based upon the document numerical score, at least one candidate document as a search result.

14. The method of claim 13, wherein the enumerating at least one term comprises generating at least one unigram term and at least one set of proximity terms.

15. The method of claim 13, wherein computing the numerical score for the at least one term is performed using the full context of the document.

16. The method of claim 13, wherein the at least one term and the numerical score for the at least one term form at least a portion of an index.

17. The method of claim 13, wherein the parsing of the user query creates at least one unigram term and at least one set of proximity terms.

18. The method of claim 13, wherein performing the logical intersection comprises retrieving a corresponding posting list for the at least one term.

19. The method of claim 13, wherein the intersection is performed on the documents in a posting list.

20. The method of claim 13, wherein a unigram term numerical score and a proximity term numerical score are combined to create a numerical score for the candidate document.
